(19) United States
(12) Patent Application Publication
(10) Pub. No.: US 2008/0270157 A1
(43) Pub. Date: Oct. 30, 2008

(54) Method and apparatus for selling disposable inflatable air mattresses as temporary bedding material

(75) Inventor: Matthew James Read, Wellesley Hills, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Applied Prototype, Inc., Franklin, MA (US)

(21) Appl. No.: 11/796,016

(22) Filed: Apr. 26, 2007

(51) Int. Cl. G06Q 30/00; G06F 17/00

(52) U.S. Cl. 705/1; 700/232

(57) ABSTRACT

A method for selling an inflated bedding material to a consumer in an automated manner includes receiving payment from the consumer, manufacturing an inflated bedding material and releasing the bedding material to the consumer. The device configured to manufacture the inflated bedding material includes a first roller with a sheet of a first material, a source of compressed air, a heat sealer, and a controller. The sheet is configured to extend from the roller, and be sealed in a first location to form a pouch with an open end, and a closed end. The source of compressed air fills the pouch with air through the open end. The inflated pouch is sealed at the closed end by the heat sealer to form the sealed inflated bedding material. The method may also be carried out without receiving funds, and in response to an emergency, or humanitarian operation.

### BACKGROUND OF THE INVENTION

Unexpected weather related emergency conditions occur with some frequency in urban and rural settings. As a result of these emergency conditions, numerous families or individuals may be temporarily displaced from their homes for a period of time, until transportation may be furnished to transport the individuals from the unsafe location to a safe location where emergency housing can be provided.

In a weather emergency related airport delay, passengers can be stranded unknowingly for hours, or days at an airport waiting for a break in the weather for the passenger to take a new flight. If a passenger lives close by, the passenger may cancel the flight, and return home, or to another sheltered location and sleep in a bed that night.

However, there is no easy solution for a non-local passenger, who arrived from a remote location, and who is waiting for a connection flight to another destination. These passengers are caught unknowingly in the weather emergency, did not plan on any extensive delay, and cannot obtain hotel accommodations at the last minute. Moreover, these non-local passengers do not know any local individuals. These non-local passengers usually wait at the airport terminal until the weather emergency is lifted, and the airline can resume operations, whereby they can then take their flight to their final destination. Often, such passengers are desperate and would gladly pay above market rates for any comfortable accommodations. Some non-local passengers in this situation may end up not sleeping at all, may sleep on the floor, or may rest intermittently on chairs or couches located in the terminal.

In other weather emergency settings, such as a hurricane, or major storm, members of the community leave their homes, and evacuate, or travel to a designated safe structure to wait out the hurricane or storm. These structures may include stadiums, schools, government centers, or hospitals. These buildings do not have sufficient storage space to house a sufficient number of cots or beds to accommodate this great number of people seeking shelter. Again, individuals may sleep on the floor, on chairs, on other makeshift items located in the shelter, or may not sleep at all.

### SUMMARY OF THE INVENTION

Costs associated with storage of beds, mattresses and cots can be very expensive. Hospitals, shelters, schools, or other organizations would like to avoid storing numerous mats, cots, or other items, and thus free up space and reduce costs associated with storing such items, while at the same time, maintain their capability to respond to an emergency.

A method for selling an inflated bedding material to a consumer in an automated manner includes receiving payment from the consumer, manufacturing an inflated bedding material and releasing the bedding material to the consumer. The device that is configured to manufacture the inflated bedding material includes a first roller with a sheet of a first material, a source of compressed air, a heat sealer, and a controller. The sheet is configured to extend from the roller and be sealed in a first location to form at least one pouch with an open end, and a closed end. The source of compressed air fills the pouch with air through the open end. The inflated pouch is sealed at the closed end by the heat sealer to form the sealed inflated bedding material.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a perspective view of a vending machine for selling a bedding material according to the present disclosure;

FIG. 1A shows a method illustrating a number of steps for selling a bedding material;

FIG. 1B shows a side view of the vending machine of FIG. 1 dispensing the bedding material;

FIG. 1C shows an enlarged view of a touch screen display of the vending machine of FIG. 1;

FIG. 1D shows a top view of the vending machine of FIG. 1 showing a device for recycling the bedding material;

FIG. 2 shows a side view of the bedding material of FIG. 1B;

FIG. 3 shows a first embodiment of the device for manufacturing the bedding material of FIG. 2;

FIGS. 3A and 3B show the rotating heat sealing member forming a pouch of the bedding material of FIG. 3;

FIG. 4 shows another embodiment of the device for manufacturing the bedding material;

FIG. 5 shows yet another embodiment of the device for manufacturing the bedding material;

FIG. 5A shows another embodiment of the device for manufacturing the bedding material from a prefabricated mattress roll;

FIG. 6 shows an inflatable disposable mattress having both a head rest pillow and a number of lengthwise oriented pouches;

FIG. 7 shows a mattress with a number of widthwise oriented pouches and a separate head rest pillow;

FIG. 8 shows another embodiment of the device for manufacturing the bedding material, where the device can control a width of the manufactured bedding material;

FIGS. 9 and 10 show mattresses with differently shaped pouches; and

FIG. 11 shows another embodiment of the device for manufacturing a multilayered inflatable bedding material.

### DETAILED DESCRIPTION OF THE INVENTION

A description of example embodiments of the invention follows.

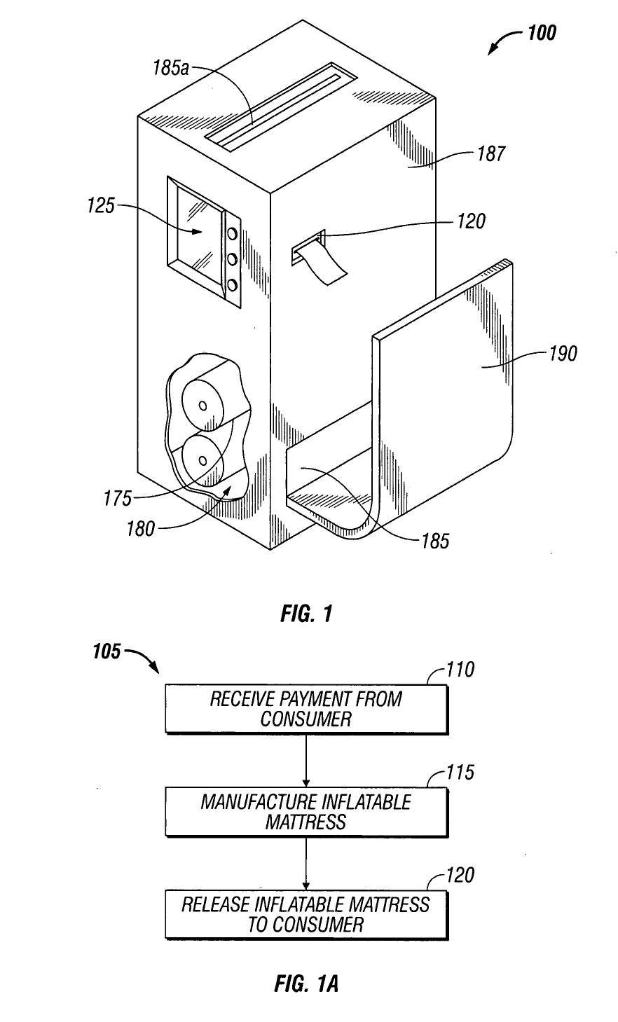

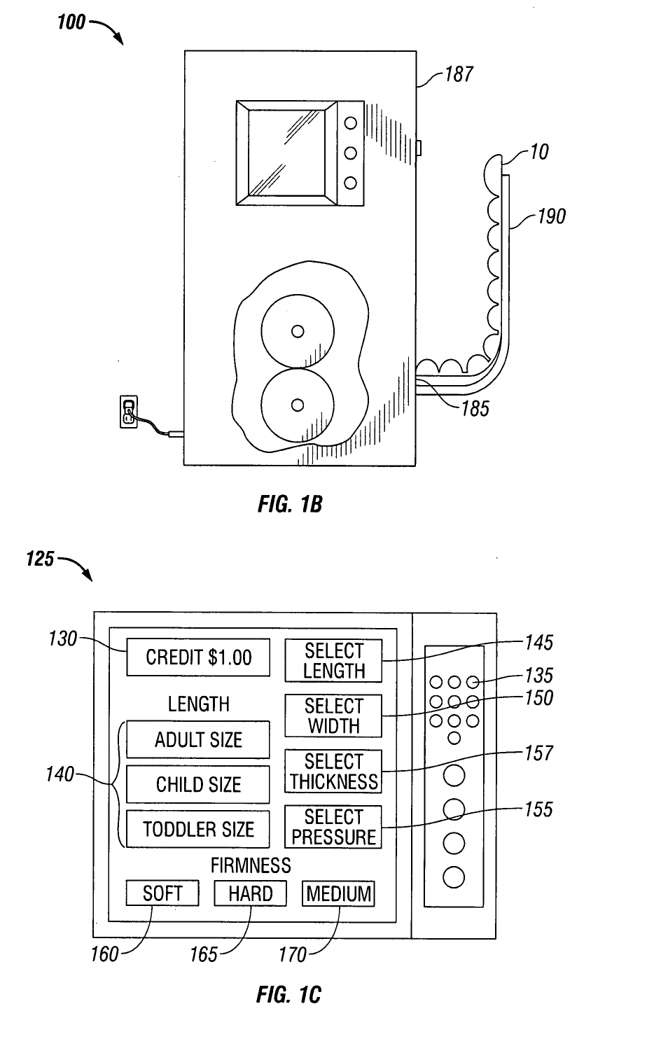

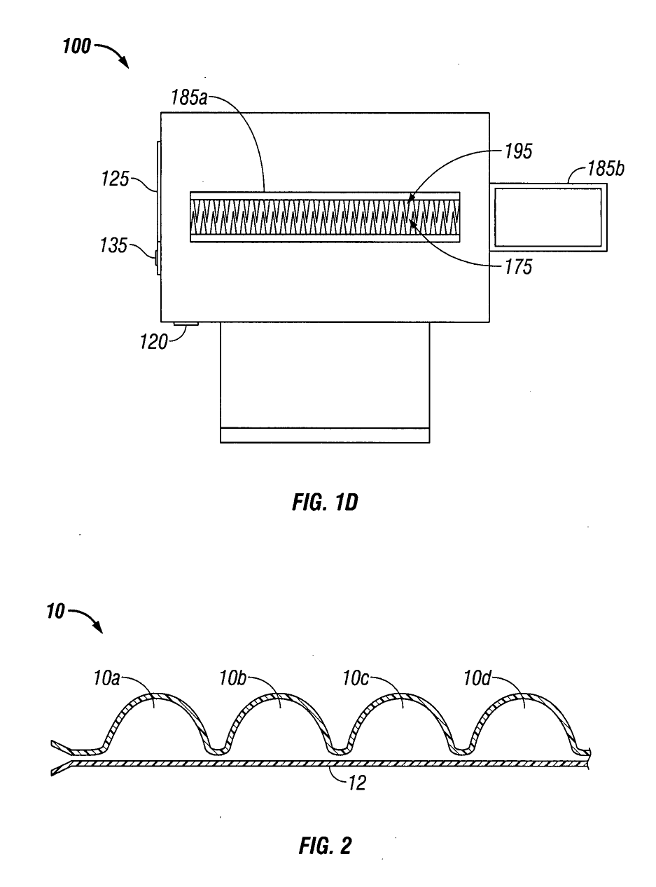

Turning now to FIG. 1, there is shown an exterior of a vending machine 100 for manufacturing a disposable air mattress according to the present disclosure. The vending machine 100 is configured to be stowed in an airport, hospital, assisting living center, daycare center, recreational center, beach, pool, or any other setting where the sheltering of individuals occurs, or where an individual may rest for a period of time. It is envisioned that the present vending machine 100 may be used in any state, federal, or local arena for humanitarian efforts, disaster relief, or any other emergency assistance capacity.

Turning now to FIG. 1A, the present vending machine 100 accomplishes a method shown with regard to a number of steps as reference numeral 105. The method 105 is directed to selling an inflated bedding material to a consumer in an automated manner. The inflated bedding material can include a mattress to lie on, a pillow to rest the consumer's head, or various other inflatable or non-inflatable configurations to assist the consumer with sleeping or resting in a location, such as a shelter, an airline terminal, or hospital for a period of time. It is envisioned that this bedding material can be placed on the floor, or used in connection with a cot, or bed.

The method 105 includes the step of receiving payment from the consumer 110. This payment 110 can be in various forms, such as an electronic form, cash, or in coin denominated funds, or the method can be accomplished free of charge in an emergency situation. The method 105 can also provide it in exchange with a voucher, or in connection with a preexisting contractual arrangement, such as with an airline ticket. Thereafter, the method 105 includes manufacturing an inflated bedding material 115, and then releasing the bedding material to the consumer 120. The manufacturing step 115 can include manufacturing the bedding material from scratch, forming the bedding material from a polymer, or can include simply assembling the bedding material, or even simply inflating the bedding material from a prefabricating material.

Referring again to FIG. 1, the vending machine 100 preferably receives funds from a user in a first location 120, and includes an input device 125. Input device 125 can be a touch screen display, a keypad, or buttons located on the vending machine 100. Alternatively, the vending machine 100 may include a wireless interface (not shown), which can communicate with remote input devices, such as, for example, a mobile phone, or Personal Digital Assistant (“PDA”). The user may insert money into a slot 120, which can be a coin slot, or paper money acceptor, and receive credits, which is displayed on the screen 125. Alternatively, the user may simply swipe a credit card into a credit card reader for payment. In an alternative embodiment, the user can receive a voucher for insertion into the first slot 120, or the vending machine 100 may be configured to dispense the mattress 10 free of charge, and without funds.

Turning now to FIG. 1C, there is shown a display screen 125 of the vending machine 100 of FIG. 1. Once the credits are displayed on the display screen 125, in touch screen field 130 and it is confirmed that the vending machine 100 received payment, the user can then use the input device 125 or keyboard 135 closely adjacent to the display 125 to select one or more desired parameters of the disposable air mattress 10. Various selectable parameters of the air mattress 10 are possible and within the scope of the present disclosure as shown by touchpad fields 140 through 170. It is envisioned that the user can select a length 145 of the air mattress that is dispensed from the vending machine 10, in feet, such as four feet, five feet, six feet, seven feet in length, etc. It is also envisioned that the user can optionally select a width 150 of the air mattress 10, such as, four feet, five feet, six feet in width. It is also envisioned that the thickness 157 of the dispensed air mattress 10 may also be input such as five inches, six inches, seven inches, and other parameters.

Moreover, the vending machine 100 is not limited to selecting width 150, thickness 157, and length 145 of the mattress 10, and other parameters may also be selected using the input device 125. Pressure 155 and firmness 160, 165, 170 parameters of the dispensed mattress 10 may also be selected. It is envisioned that pressure 155 of the inflated mattress 155 may also be input using keyboard 135 in pounds per square inch. It is also envisioned that the user may select other parameters including sizes depending on the age group of the individual, such as, for example, an adult size, a child size, a toddler size, and a teenager size for convenience instead of inputting various parameters.

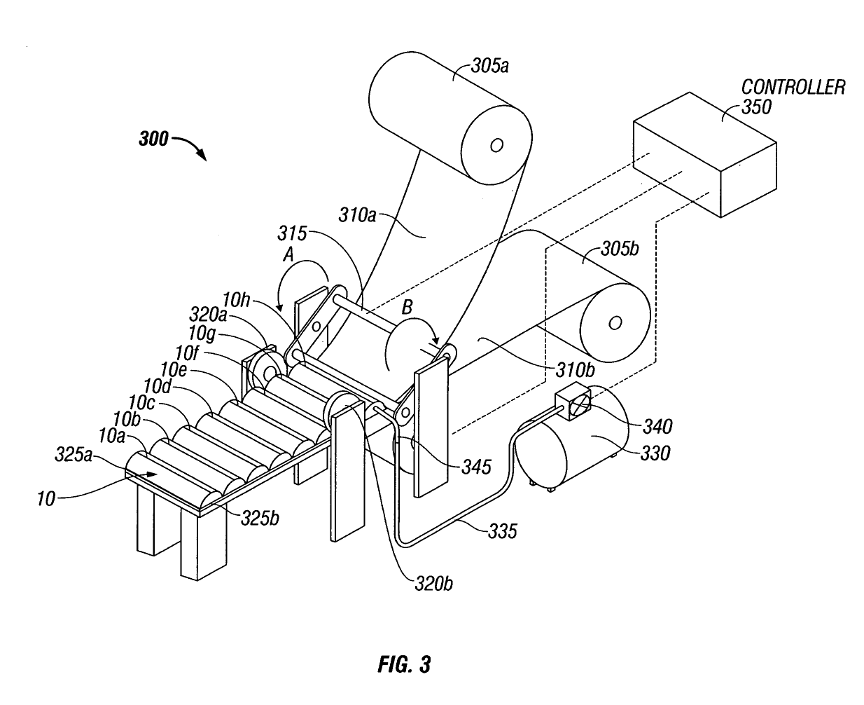

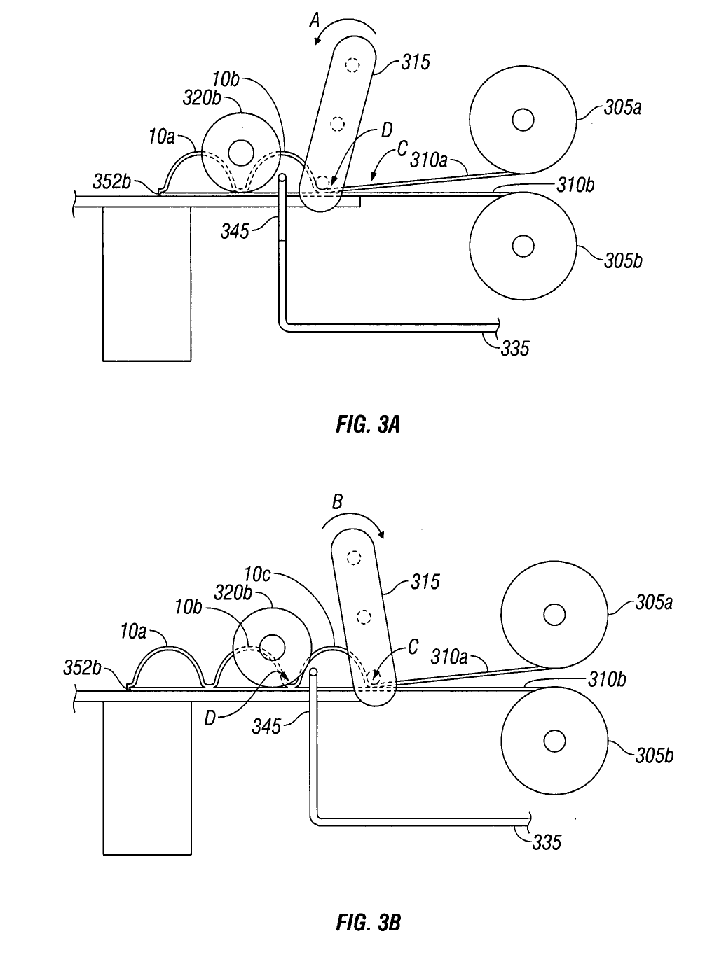

Various combinations of parameters are possible and within the scope of the present disclosure, and it is envisioned that the vending machine 100 may include a microprocessor controller (FIGS. 3 through 5A) with a memory for running instructions program to assist the consumers with the selection process. The display 125 may display only categories, such as small, medium, and large inflated mattress categories with a firmness designation such as firm, medium, and soft. Additionally, it may display other categories, and the user may simply select existing formats using the input device 110, such as adult, child, or toddler generally shown as reference numeral 140.

It is also envisioned that the vending machine 100 may dispense a standard mattress for a preset cost. Thereafter, the user may select additional parameters, such as extra firmness 165, and 170, and increase the pressure in the disposable mattress 10 for an additional cost that is then added to the total purchase price field 130. For example, a standard mattress may cost $1.00, but for a seven foot long mattress, this feature may increase the purchase price to $2.00.

Referring again to FIG. 1, the vending machine 100 preferably includes an interior space 175 that is sized to house an apparatus for manufacturing a disposable inflatable mattress shown as reference numeral 180. Mattress 10 is output to the user through an exit port 185 of the vending machine 100. The vending machine 100 also includes a rail or stainless steel track 190. The track 190 is generally a cantilevered bar-like member. The track 190 is generally curved so as to be substantially parallel to the vending machine housing 187, and is connected to a vending machine housing 187 in a location that is disposed adjacent to a vending machine exit port 185. Track 190 preferably retains the inflatable air mattress 10 in an upright location parallel to the vending machine 100, and will hold mattress 10 during dispensing of the mattress 10 from the vending machine 100 as shown in FIG. 1B, so the consumer may take it away.

The air mattress 10 shown in FIG. 2 is preferably for short term use, such as, for example, use for a night during an airport delay, use in a hospital stay, or in connection with an emergency temporary situation. Preferably, the disposable inflatable mattress 10 can be used for one night, or at most five days, or even in another embodiment permanently and preferably is dispensed in an inflated manner. Mattress 10 also has a standard thickness of above three inches from top to bottom, however this is not limiting and it may be made in any desired configuration with any thickness. The mattress 10, when inflated, has a number of pouches 10a, 10b, 10c, 10d filled with a gas at a predetermined pressure. Pouches 10a, 10b, 10c, 10d are supported on a base layer 12. At the conclusion of use, turning again to FIG. 1D, the vending machine 100 includes a feature that the user can insert the bedding material, or mattress 10 back into the vending machine 100 for destruction and recycling. In this aspect, the vending machine 100 includes an additional recycling port 185a.

The recycling port 185a is shown on a top side of the vending machine housing 187, but it should be appreciated that it may be located in any convenient accessible location. Recycling port 185a is a generally rectangular shaped aperture that communicates with the interior space 175 of the vending machine housing 187. The user can manipulate the inflatable disposable mattress 10 into the vending machine 100 through the recycling port 185a, and it should be appreciated that the recycling port 185a is suitably sized so any number of sized mattresses 10 can be fitted therein.

Turning now to FIG. 1D, the port 185a preferably communicates with a shredding device 195, and a receptacle (not shown). Receptacle is positioned in the interior space 175 of the machine 100, or is connected thereto. The shredding device 195 preferably cuts and destroys the inflatable disposable mattress 10, and renders it into pieces for storage in the receptacle (or for storage outside of the vending machine 100) in a safe and protected manner. It should be appreciated that the shredding device 195 may include a stationary and a moveable blade (not shown), and finger guard (not shown). The shredding device 195 may be any other known device for a controlled destruction of the inflatable disposable bedding material 10 into pieces in a quick and easy manner, and that can permit these pieces to be stored for layer retrieval, and recycling from the receptacle (not shown). The shredding device 195 may be activated using input device 125 or by an automatic sensor. In another embodiment of the present disclosure, the shredding device 195 may communicate with a compacting device 185b. Device 185b can compact the shredded material, to reduce a volume of the shredded material, and to store the reduced volume compacted waste material until it is removed for recycling or until it is discarded. It should be appreciated that the compacting device 185b is optional, and the present machine 100 is not limited to such a compacting device 185b.

Turning now to FIGS. 3 through 8, there is shown several configurations for the device 300 for manufacturing the inflatable disposable mattress 10 according to the present disclosure. Various manufacturing configurations are possible and within the scope of the present disclosure, and the present devices are not limiting, and are merely illustrative of the present invention. The device 300, shown in a first embodiment, includes one or more rolls 305a, 305b of a malleable material, for example, a thermoplastic polymer, such as polyvinyl chloride. Examples of sheet materials which may be used include those formed from thermoplastic polymers, including, but not limited to, polyolefins such as polypropylene and polyethylene, polyamides, polyesters such as polyethylene terephthalate, thermoplastic elastomers such as polyurethanes, and so forth. Various polymer configurations with varying thicknesses, material textures, and additives are possible and within the scope of the present disclosure.

In the embodiment shown in FIG. 3, the vending machine 100 includes a first roll of polyvinyl chloride plastic 305a, and a second roll of the same or a different material 305b. It is also envisioned that the rolls 305a, 305b are supported using a support structure that is not shown for illustration purposes, which is supported in the vending machine 100. A first sheet 310a, and a second sheet 310b are pulled from the first and the second rolls 305a, 305b using a retaining member or similar reel (not shown). The apparatus also includes a number of heat sealing devices 315, 320a, and 320b.

Preferably, a first lateral edge 325a of the first and the second sheets 310a, 310b are joined by a first lateral heat sealing device 320a. A second lateral edge 325b of the first and the second sheets 310a, 310b are also thermally joined to one another by a second lateral heat sealing device 320b. The second lateral heat sealer device 320b is disposed on an opposite side of the first heat sealing device 320a. Preferably, an electric current is supplied to a conductive member on heat sealing devices 320a, 320b to heat the conductive member, and to transmit this thermal energy to the first and the second sheets 310a, 310b. This thermal energy elevates the temperature of the first and the second sheets 310a, 310b causing the first and the second sheets 310a, 310b to undergo a phase change, and thereby thermally bond the first and the second sheets 310a, 310b to one another. Various heat sealer configurations are possible and within the scope of the present disclosure.

The apparatus also has a rotating heat sealing device 315 to form any number of pouches 10a through 10e of the inflatable disposable mattress 10. The number of pouches 10a through 10e are preferably proportional to the desired length of the inflatable disposable mattress 10. Preferably, the inflatable disposable mattress 10 is ejected from the vending machine 100 in a fully inflated manner, and thus each of the pouches 10a through 10e of the inflatable disposable mattress 10 is sealed with gas. It is also contemplated that, alternatively, “a non-fully inflated” air mattresses 10 may be ejected and the user can then self inflate the disposable mattress 10, however this configuration is less preferred.

The rotating heat sealing device 315 preferably rotates in a first rotational direction show as reference arrow A, and then also in a second rotational opposite rotation direction (reference arrow B) to intermittently contact and seal the sheets 310a, 310b forming the air mattress 10 and to form the pouches 10a through 10e. Preferably, the rotating heat sealing device 315 forms a first pouch 10a, and a second pouch 10b, and then continues for as many additional pouches are needed.

Turning now to FIG. 3A, the rotating heat sealing device 315 first moves in the direction of arrow A. Device 315 then contacts first and second sheets 310a, 310b to commence formation of a pouch 10c (FIG. 3B) with a first opened end C, and a second closed end D. Turning now to FIG. 3B, thereafter, a source of compressed air fills the pouch 10c with compressed air. The rotating heat sealing device 315 can then rotate in the rotational direction B. Device 315 contacts the pouch 10c at the open end C to heat seal the pouch 10c at the open end C. It should be appreciated that the top roll of material should include more material than the bottom layer to accommodate the folding to form the pouches 10a through 10c in the above embodiment.

Turning now back to FIG. 3, the source of compressed air may include a tank 330 that is connected to a hose 335 and a valve 340 that selectively can release a predetermined quantity of compressed air into the inflatable disposable mattress 10 to inflate mattress 10. Various compressed gases can be used, such as any inert gas, carbon dioxide, air or oxygen. In another embodiment, the source of compressed air may not come from a tank 330, as shown, but instead the machine 100 can include a fan (not shown) that is located in ambient conditions. Fan (not shown) blows compressed air into the inflatable disposable mattress 10 through a conduit 345 to inflate mattress 10. Various inflation configurations are possible and within the scope of the present disclosure.

Thereafter, the rotating heat sealer 315 may rotate in an opposite rotational direction A to form another pouch with an open end, and a closed end. The source of compressed air 330 can then fill the next pouch by introducing air into the pouch, and the rotating heat sealer 315 can then rotate again in the rotational direction as shown by reference arrow B to seal the next inflated pouch at the opened end. This process may continue, and be controlled by a controller 350, which may form any number of pouches 10n from the first sheet 310a and the second sheet 310b that are needed to form the desired length of the mattress 10.

Turning now again to FIG. 2, inflated disposable air mattress 10 can include a top side having a number of pouches 10a through 10d resulting from the rotating heat sealer 315, and a flat bottom side 12 corresponding to the second sheet of thermoplastic 310b as shown. In this embodiment, the pouches 10a through 10d may include a height of about three inches, and the rotation of the rotating heat sealer device 315 can selectively control the height of the undulating pouches 10a through 10d, and the overall inflated thickness of the inflatable disposable mattress 10.

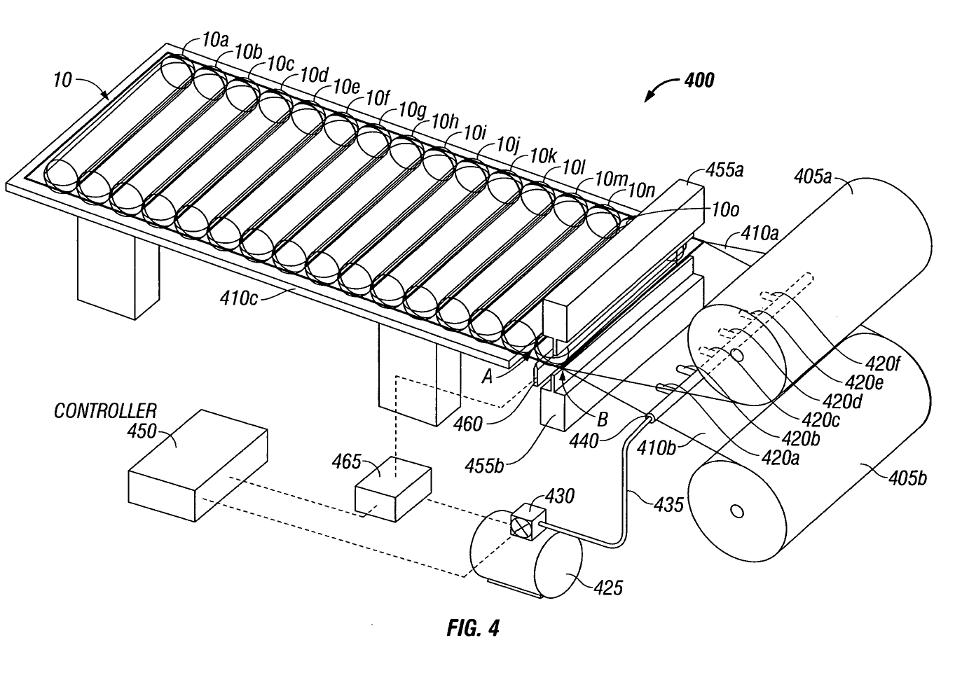

Turning now to FIG. 4, there is shown another configuration of the device 400 to manufacture the inflatable disposable mattress 10 according to the present invention, and that is disposed in the vending machine housing 187 shown in FIG. 1. In this embodiment, the device 400 includes a pair of rollers 405a, 405b that each retain a sheet of a malleable material, such as a polyvinyl chloride, or a first sheet 410a, and a second sheet 410b. Preferably, as with the embodiment described above, the first sheet 410a and the second sheet 410b are pulled from the first and second rollers 405a, 405b using a retaining finger or reel (not shown) on a table 410c to properly orient the first and the second sheet 410a and 410b relative to one another in an aligned manner. It should be appreciated that top roller 405a typically may use more material than the bottom roller 405b with this extra material being attributed to the forming of the pouches of mattress 10.

In one embodiment, the first and the second sheet 410a and 410b can be supported on a moving track (not shown) instead of the table or rail 410c to advance sheets 410a and 410b forwardly or rearward as desired, however, the moving track (not shown) is optional. The moving track or conveyor belt (not shown) instead of the table 410c may be connected to a switched reluctance motor (not shown), which is connected to a controller 450 which controls the advancement of the moveable track in a controlled manner to manufacture, and to inflate the pouches 10a through 10n, and then eject the mattress 10 to the consumer.

The device 400 also includes a plurality of nozzles 420, or a first through sixth nozzles 420a, 420b, 420c, 420d, 420e, and 420f that all communicate with a source of compressed air 425 having a valve 430. Alternatively, each nozzle may have its own valve. Nozzles 420a, 420b, 420c, 420d, 420e, and 420f communicate with valve 430 through a hose 435 or similar conduit as shown. The nozzles 420a through 420f each have a configuration with an inlet that is connected to the source of compressed air 425 and an outlet that directs gas into the opening of the pouches 10a through 10n and that form the inflated air mattress 10.

As shown in FIG. 4, the source of compressed air 425 is connected to a feeder tube 440 having the number of nozzles 420a, 420b, 420c, 420d, 420e, and 420f positioned along the length of the feeder tube 440 at predetermined intervals across the feeder tube 440. Likewise, the feeder tube 440 includes spaced apertures that communicate with each of the nozzles 420a, 420b, 420c, 420d, 420e, and 420f along the length. Tube 440 provides a source of compressed air or gas 425 into the interior of the formed pouches 10a through 10n. The feeder tube 440 is connected to valve 430, and the valve 430 is also connected to the controller 450. The controller 450 can be a microprocessor that has a memory that includes a set of program instructions that controls the valve 430. Controller 450 can time a burst of air from the source of compressed air 425 to the feeder tube 440 and to the nozzles 420a, 420b, 420c, 420d, 420e, and 420f in order to fill the formed pouches 10a through 10n with the compressed air, and will continue filling until the pouches 10a through 10n are sealed by the heat sealing devices 455a, and 455b and thereby inflated.

The device 400 for manufacturing the inflatable disposable mattress 10 further includes heat sealing devices 455a, 455b. Devices 455a, 455b thermally join the first sheet 410a and the second sheet 410b together in a first location to form a closed end A of a pouch 10o. Thereafter, the mattress 10 is advanced in a distal manner on the table 410c, or optionally by using a conveyor belt, or moveable track. Sheets 410a, 410b are joined to one another form the pouch 10o having the closed end A, and an opened end B. The controller 450, once mattress 10 is advanced distally, will then actuate the valve 430. The valve 430 permits the source of compressed air 425 to communicate with the feeding tube 440, and the compressed air that is located in tank 425 flows from the tank 425 into conduit 435 to the feeding tube 440, and through the nozzles 420a, 420b, 420c, 420d, 420e, and 420f. The compressed air will then enter into the pouch 10o through the opening B. Once inflated, the heat sealers 445a, 455b will then seal the opening B of the inflated pouch 10o. This process will repeat for a second pouch, a third pouch, and so on for as many pouches are needed to form the required mattress length that is input by the user, such as seven feet, eight feet, etc., as shown in FIG. 1B.

Further, he controller 450 may control the amount of pressure that is placed in each of the pouches 10a through 10o depending on the consumer preference, and the parameter that the consumer selects as shown in FIG. 1C. Preferably, the controller 450 may receive an input signal from touch screen field 155 as shown in FIG. 1C (or another different input device or keyboard) that the consumer wishes a particularly firm mattress. In response to this input signal, the controller 450 can control the valve 430 to open and release a relatively larger amount of compressed air provided to the feeder tube 440, and likewise to the nozzles 420a, 420b, 420c, 420d, 420e, and 420f.

It should also be appreciated that the tank 425 has compressed gas therein, which is non-flammable, and safe for commercial use, and may encompass air, carbon dioxide, an inert gas, or any other commercially available gas known in the art.

In yet another embodiment, the device 400 for manufacturing the inflatable disposable mattress 10 can be made without the tank 425, but instead be formed with a fan or suitably rated fan with blades to deliver gas to the feeder tube 440 and to the nozzles 420a, 420b, 420c, 420d, 420e, and 420f.

In this embodiment, instead of rotating, heat sealing devices 455a, 455b move vertically with respect to one another. In one embodiment, the first top heat sealer 455a may be connected to a pneumatic device (not shown), and move vertically with respect to a stationary second bottom heat sealer device 455b. In another embodiment, the second (bottom) heat sealer device 455b may move vertically with respect to the stationary top heat sealer 455a, and be connected to the pneumatic device (not shown). In a further embodiment, both the first and the second heat sealers 455a, 455b may move vertically with respect to one another. In a further embodiment, the first and second heat sealers 455a, 455b may be stationary, and an optional conveyor belt (not shown) or an optional moveable track (not shown) can move to accomplish the relative vertical movements. Additionally, first and the second heat sealing devices 455a, 455b may be stationary, and only the mattress 10 moves to accomplish the relative vertical movement.

The heat sealing devices 455a, 455b preferably include a thermally conductive material (not shown), such as a metal, connected to a source of power (not shown). The conductive metal preferably contacts the first and the second sheet of material 410a, 410b, and conducts thermal energy to the first and the second sheets 410a, 410b to raise the temperature of the thermoplastic a sufficient amount to undergo a phase change, and thereby join the first and the second sheets 410a, 410b together, such that when they cool they form a resilient and sturdy single member that is sealed and does not permit gas to escape. Various material thickness configurations for the first and the second sheets 410a, 410b, are possible, and thus, various different heat sealing devices 455a, 455b are possible and within the scope of the present disclosure to achieve a bond between the first and the second sheets 410a, 410b.

For polypropylene-based sheet materials, which are available from Kimberly-Clark Corporation having an office in Neenah, Wis., if the roll diameter is between about 5 inches and about 17 inches and the material mass is between about 2.0 ounces per square yard and about 2.5 ounces per square yard, the temperature of the heat sealer devices typically will range between about 280 degrees Fahrenheit to about 400 degrees Fahrenheit for effective, continuous bonding. It should be appreciated that the temperature of the outer peripheral surface of each heat sealing device 455a, 455b will vary depending on the application, and that the ranges provided above are merely by way of example. In another embodiment of the present invention, the heat sealing devices 455a, 455b are impulse heat sealing devices from MCMASTER-CARR® of Atlanta, Ga. Devices 455a, 455b include a timer (not shown) to set a length of a heating time, and may reach a temperature of at least 750 degrees Fahrenheit. Various temperature ranges are possible and within the scope of the present disclosure.

The device 400 optionally includes a cutting device, or blade 460 shown separated from the device 400, for illustration purposes, to separate the bonded inflated first and second sheets 410a, 410b from the respective first and second rolls 405a, 405b at the conclusion of forming the disposable inflatable mattress 10. The cutting device 460 may be connected to an actuator 465, that is operatively connected to the controller 450. Actuator 465 safely controls the cutting device 460. At the conclusion of inflating and forming the desired number of pouches 10a through 10o, (and once the length is sufficient to the desired length input by the consumer), the controller 450 may control the actuator 465 to actuate cutting device 460. Once energized, the cutting device 460 will commence cutting the disposable inflatable mattress 10 free from first and second sheets 410a, 410b, and then permit the mattress 10 to be moved to the user. Optionally, a conveyor belt or a track (not shown) moves the disposable air mattress 10 to the user.

It should be appreciated that instead of an optional discrete cutting device 460, the device 400 may be manufactured so the heat sealing devices 455a, 455b sever the disposable inflatable mattress 10 from the first and the second sheets of material 410a, 410b using thermal energy. The first and the second heat sealing devices 455a, 455b may have two modes of operation, or a first bonding mode, where an amount of thermal energy is supplied to bond the first and the second sheets together 410a, 410b, and a second cutting mode, where a greater amount of thermal energy is applied (relative to the first mode) for severing the disposable inflatable mattress 10 from the first and the second sheets 410a, 410b. This increased thermal energy may be controlled by the controller 450, or another digital device or circuit. It should be appreciated that the device 400 also includes clips or a device (not shown) for retaining and aligning the first and the second sheets 410a, 410b, for the next manufacturing operation, and to prevent the first and the second sheets from 410a, 410b becoming misoriented and thereby dislodged from the table, support surface, or rail 410c.

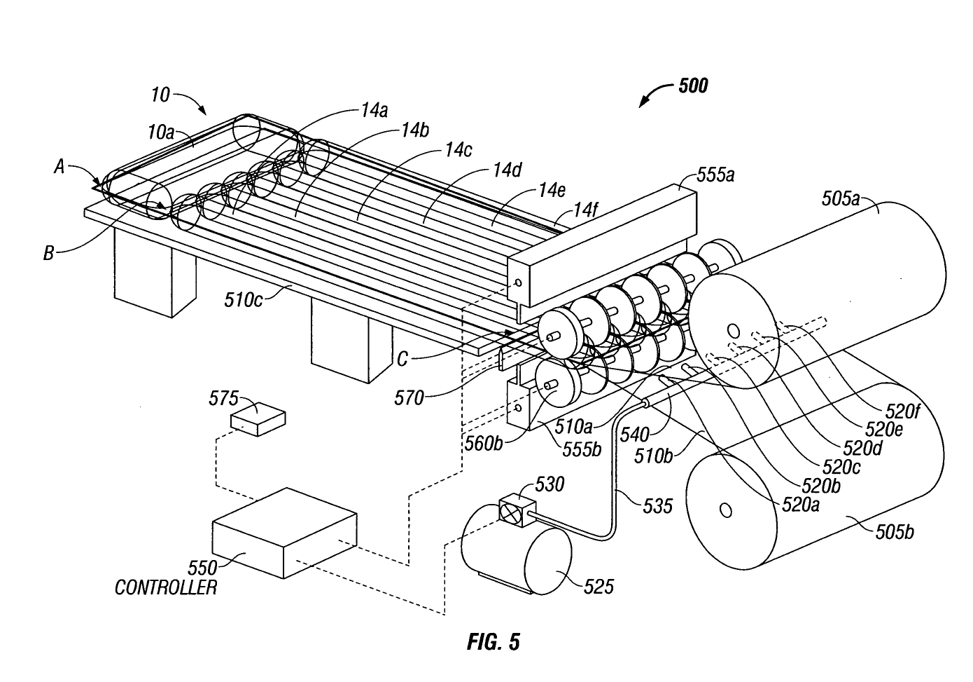

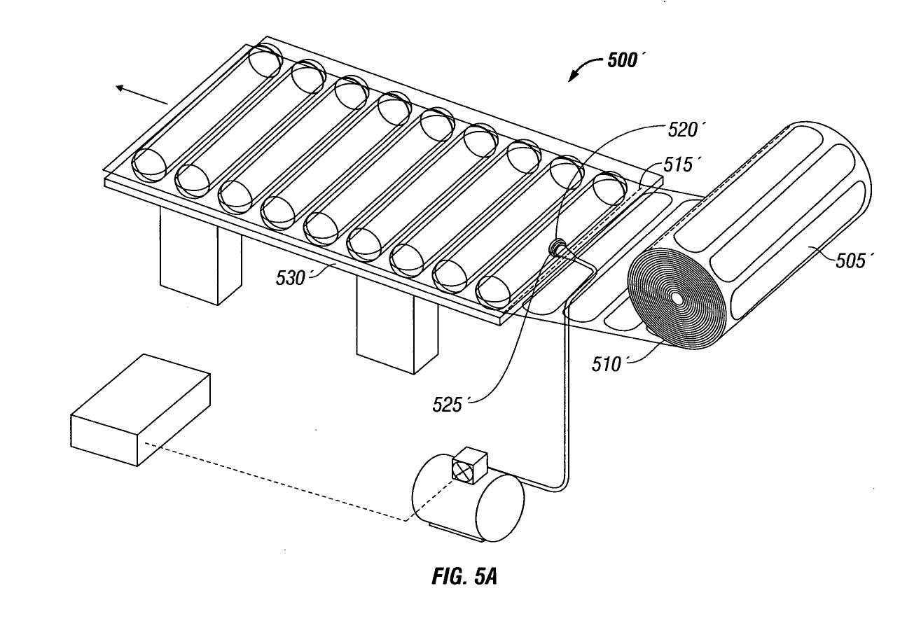

Referring now to FIG. 5, there is shown another embodiment of device 500 for manufacturing the disposable inflatable mattress 10. Device 500 can form both lengthwise shaped pouches 14a, 14b, 14c, 14d, 14e, and 14f, and a width wise shaped pouch 10a on the same disposable air mattress 10. Preferably, the controller 550 may output program instructions to the various assemblies of the device 500 to form both a widthwise, or head rest pouch 10a, then seal the disposable air mattress 10, and then form a number of lengthwise pouches 14a through 14f having a predetermined desired length.

In this embodiment, the device 500 for manufacturing the disposable air mattress 500 includes a first roll of material 505a, and a second roll of material 505b, which are supported in the vending machine housing 187 (FIG. 1) by a support structure (not shown). A first sheet 510a of a malleable material, such as a polymer, or any of the previously described materials extends from the first roll 505a. A second sheet 510b of material, likewise, extends from the second roll 505b. It is envisioned that a single roll operation is also possible and the two rolled configurations are merely illustrative of one non-limiting embodiment. The device 500 also includes a number of nozzles 520a through 520f connected to a feeder tube 540. Tube 540 is connected to a source of compressed air 525 through conduit 535 and for inflating the disposable inflatable mattress 10. As shown, the nozzles 520a through 520f are advantageously disposed between the first and the second rollers 505a, 505b to ensure compressed air is introduced between the sheets 510a, 510b.

The device 500 also includes a pair of heat sealing devices 555a, 555b. As mentioned, each device 555a, 555b can vertically move, or move relative to one another as previously discussed to seal the first and the second plastic sheets 510a, 510b. First heat sealing device 555a can move vertically, the second heat sealing device 555b can move vertically, or both can move vertically, or be stationary with the sheets 510a, 510b moving, as previously discussed.

In addition, the device 500 includes a first and a second impulse heat sealing rollers 560a, 560b. The first heat sealing roller 560a is disposed above the first sheet 510a, and the second heat sealing roller 560b is positioned below the second sheet 510b. Both rollers 560a, 560b may also be connected to a pneumatic device or an actuator (not shown) to further move the first and second heat sealing rollers 560a, 560b in a direction toward or away from the first and the second sheets 510a, 510b. The pneumatic device also is connected to a controller 550 which can control operation and the vertical movement of the heat sealing rollers 560a, 560b.

In operation, the mattress 10 is advanced on the table 510c in a forward or distal manner. Here, the first and the second vertical heat sealing devices 555a, 555b may move relative to one another to make a first seal shown in location A. Here, the devices 555a, 555b bond the first sheet 510a to the second sheet 510b to form a pouch 10a with an opened end B, and a closed end A. Thereafter, the controller 550 may actuate value to release air through the nozzles 520a through 520f. This releases compressed air into the head rest pouch 10a, and once inflated sufficiently, the mattress 10 may continue to move in a distal manner. To seal the pouch 10a, the first and second vertical heat sealers 555a, 555b may then move relative to one another to contact and bond the first sheet 510a to the second sheet 510b at the open end B to form the head rest pouch 10a.

To now form the lengthwise oriented pouches 14a through 14f, the controller 550 will output a control signal to move the first and the second vertical heat sealing devices 555a, 555b. The vertical heat sealing devices 555a, 555b will withdrawal from the manufacturing operation, or more particularly move away from the first and the second sheets 510a, 510b. The controller 550 will then send a control signal to move the rollers 560a, 560b in a direction toward the first and the second sheets 510a, 510b from a withdrawn or stowed position. First rolling heat sealing device 560a will then contact the first sheet 510a from above. The second rolling heat sealing device 560b will then contact the second sheet 510b from below.

Both the first rolling heat sealing device 560a and the second rolling heat sealing device 560b will heat the respective first and the second sheets 510a, 510b, and raise the temperature of the first and the second sheets 510a, 510b to join the first and the second sheet 510a, 510b to one another in location where the first and the second heat sealing rollers 560a, 560b make contact, and in an aligned manner.

Next, to inflate pouches 14a through 14f, the controller 550 will then also control the valve 530, and the compressed air will flow from the source 525 to the feeding tube 540, and to the nozzles 520a through 520f. The compressed air will flow from the nozzles 520a through 520f into the disposable mattresses 10 to inflate the mattress 10. The disposable mattress 10 is moved distally during the inflation to form the number of lengthwise oriented pouches 14a through 14f. Once the appropriate length of the mattress 10 is achieved, then the inflated mattress 10 is ready to be heat sealed closed, cut, and then released from the vending machine 100 to the user shown in FIG. 1.

Once the desired length of the mattress 10 is achieved, then the controller 550 can send a control signal to actuate the first and the second heat sealing devices 555a, 555b. The vertical heat sealers 555a, 555b in response to the signal may activate, and move toward the inflatable disposable mattress 10 to seal the mattress 10 at the opened end shown as location C. Thereafter, the controller 550 can then send a control signal to keep the first and the second vertical heat sealers 555a, 555b applied to the inflatable mattress 10 to sever the connection between the inflatable disposable mattress 10 and the respective first and second sheets 510a, 510b.

In another embodiment, an optional cutting device 570, or an electric blade having a serrated edge may be provided, which is shown spaced away in an exploded manner for illustration purposes. The electric cutting device 570 is connected to actuator 575, which can be energized with power from the power source, and be actuated to cut the inflated disposable mattress 10 free from the first and the second sheets of material 510a 510b, in response to the control signal from controller 550 (instead of using devices 555a, 555b).

Turning now to FIG. 5A, there is shown an alternative embodiment of the present disclosure. In this embodiment, the device 500′ for manufacturing the inflatable mattress 10 occurs in a different manner. Here, the device 500′ does not include any bonded thermoplastic sheet(s), but instead includes a prefabricated material 505′ that is formed in a roll 510′. The prefabricated material 505′ includes a first sheet bonded to another sheet in a pre-sealed manner. Prefabricated material 505′ forms a number of disposable air mattresses 10 that are separated by perforations 515′, and only need to be inflated. The prefabricated material 505′ can be formed to include a check valve 520′ and an inflation port 525′, so that the prefabricated material 505′ can be manipulated, and advanced distally on the table 530′, and then inflated. Thereafter, once inflated, the disposable air mattress 10 can then be separated from the remainder of the prefabricated roll 505′, and the inflatable mattress 10 then can be moved distally to the vending machine output 185 shown in FIG. 1.

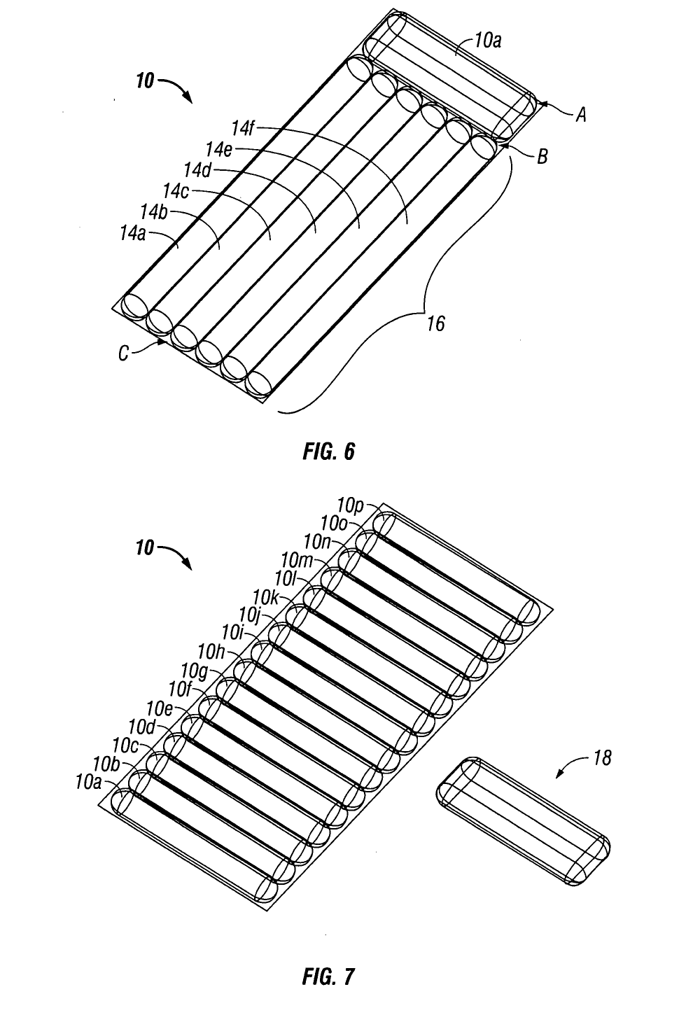

Turning now to FIG. 6, there is shown a completed disposable mattress 10 having a head rest pouch 10a, or pillow, and a body portion 16 with a number of lengthwise oriented pouches 14a through 14f that are sealed at both ends B, C, and shown in comparison to the embodiment of FIG. 7. As mentioned, the mattress 10 of FIG. 7 does not include a head rest pouch 10a, and instead includes a number of widthwise pouches 10a through 10p as shown, which may be output with a separate pillow 18 for an extra fee. It should be appreciated that the machine 100 may be programmed so the mattress 10 embodiment of FIG. 7 may be manufactured with a headrest pouch 10a similar to the embodiment of FIG. 6. It should be appreciated that the embodiment shown (without the headrest pouch 10a) is not limiting, and is simply provided for illustration purposes only. Each of the embodiments, can be made in various sizes or thicknesses, and include different pressure or firmness parameters, which is advantageous.

Preferably, each of the embodiments lasts for three to five days, or longer (or permanently) and can provide temporary bedding solutions with a capability to be recycled at the vending machine 100. It is also envisioned that the vending machine 100 may prompt the user for a size of the head rest pouch 10a of FIG. 6, and can form various pouches with each pouch having a different size relative to one another for convenience, and as desired by the user. It is further envisioned that the vending machine 100 may form the inflatable mattress bed 10, and then subsequently for an extra fee manufacture a relatively smaller size disposable inflatable pillow 18 to be used in connection with the freshly made mattress bed 10 shown in FIG. 7. Various geometrics/configurations are possible and within the scope of the present disclosure, and it is envisioned that a folded sheet may accompany or be sold separately in the vending machine.

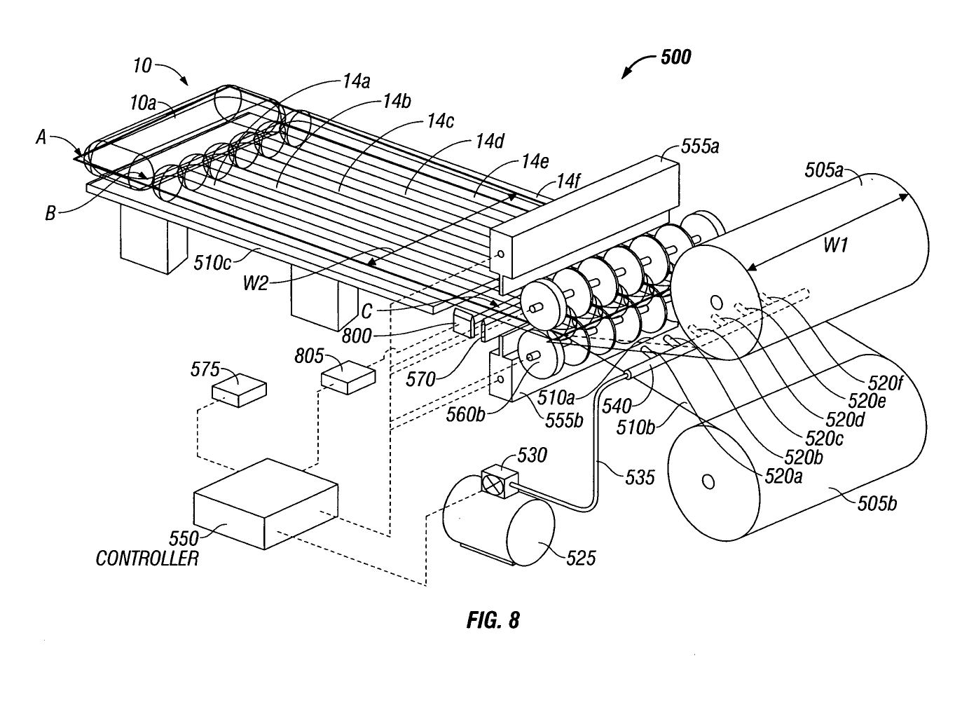

Turning now to FIG. 8, it should be appreciated that typically, the width parameter of the mattresses 10 described above is generally fixed, and can be dependent on the width W1 of the roll 505a, 505b stored in the machine 500. However, it should also be appreciated that the width W1 of the mattress 10 may also be controlled, and the machine 500 may be configured to manufacture a mattress 10 with an initial width W1, and is configured to then further cut the mattress 10 from the width W1 to a desired width W2, which is different than W1. The machine 500 may be configured to include one or more additional cutting device(s) 800. Cutting device 800 is connected to an actuator 805 (which can be the same as or different relative to the actuator 575), and, is also connected to the controller 550. Actuator 805 can be a pneumatic device (not shown) that is operable to move the cutting device 800 in a manner that is substantially perpendicular or parallel relative to the mattress 10 to cut the mattress 10 to a selected width W2, and as determined by program instructions output by the controller 550. It should be appreciated that the machine 500 may include one single cutting device 800, which is moveable, or a plurality of cutting devices 800, and 570 to selectively modulate the width W1 of the mattress 10. Various mattress width trimming configurations are possible and within the scope of the present disclosure.

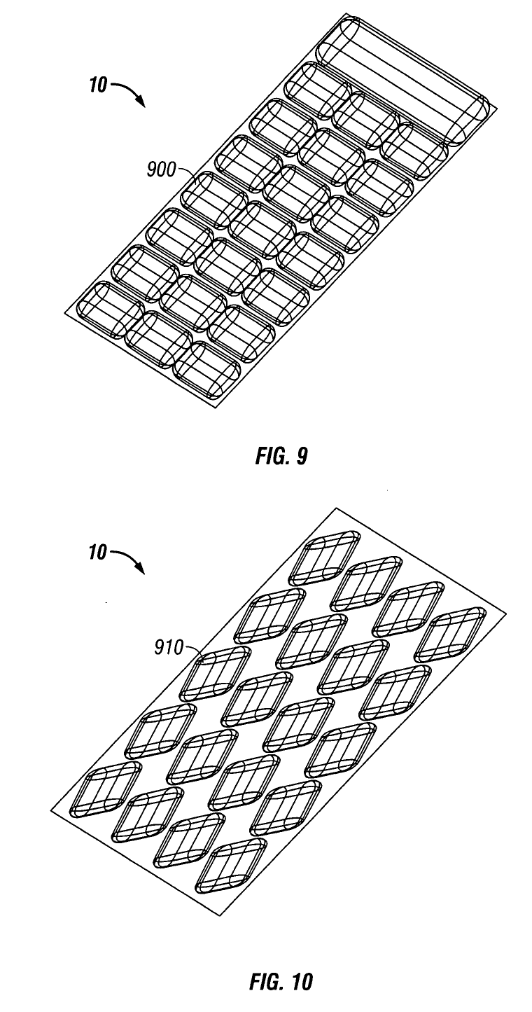

Turning now to FIG. 9, it should be appreciated that the mattress 10 may be made with a number of pouches 900 that includes a plurality of square shaped pouches 900, or alternatively, as shown in FIG. 10, the mattress 10 may be configured to be made with a number of diamond shaped pouches 905. These pouches 900, 905 may be manufactured or inflated, and any shaped pouches are envisioned, and can be selected for comfort or strength, such as, for example, generally ball shaped protrusions, spherical, triangular, polygonal or any other desired shape or configuration.

Turning again to FIG. 1, it should be appreciated that the apparatus 100 may be made not as a vending machine having a receptacle 120 for receiving funds, but instead be made to provide free, quick, on-site, disposable mattresses. These machines may be used by hospitals, day care centers, camps, airports, emergency centers, nursing homes or any other facility that may desire disposable and/or configurable mattresses.

In addition, such an embodiment might be used in connection with a humanitarian operation, or rescue/first responder configuration. In this capacity, the apparatus 100 may be mobile, and include wheels, or a motorized operation, and include a mobile power supply (such as, for example, nickel cadmium batteries, lithium ion batteries, or any other suitable mobile power supply known in the art). Apparatus 100 can be configured to be brought (or dropped) into a region using a truck, plane, boat, or other transportation device to rapidly output a number of inflatable mattresses 10, such as, for example, hundreds at a time, to provide the mattresses 10 to victims of an emergency, or natural disaster, such as, for example a hurricane whether individuals lack shelter. Further, the device 180 may be configured with multiple rolls of sheets, and configured to manufacture several inflatable mattresses 10 in response to the emergency. It is envisioned that the machine 100 may be configured for use with more than two rolls shown in FIG. 5, and may include three rolls, four rolls, or more to manufacture hundreds of mattresses 10 in a rapid manner, and in response to an emergency.

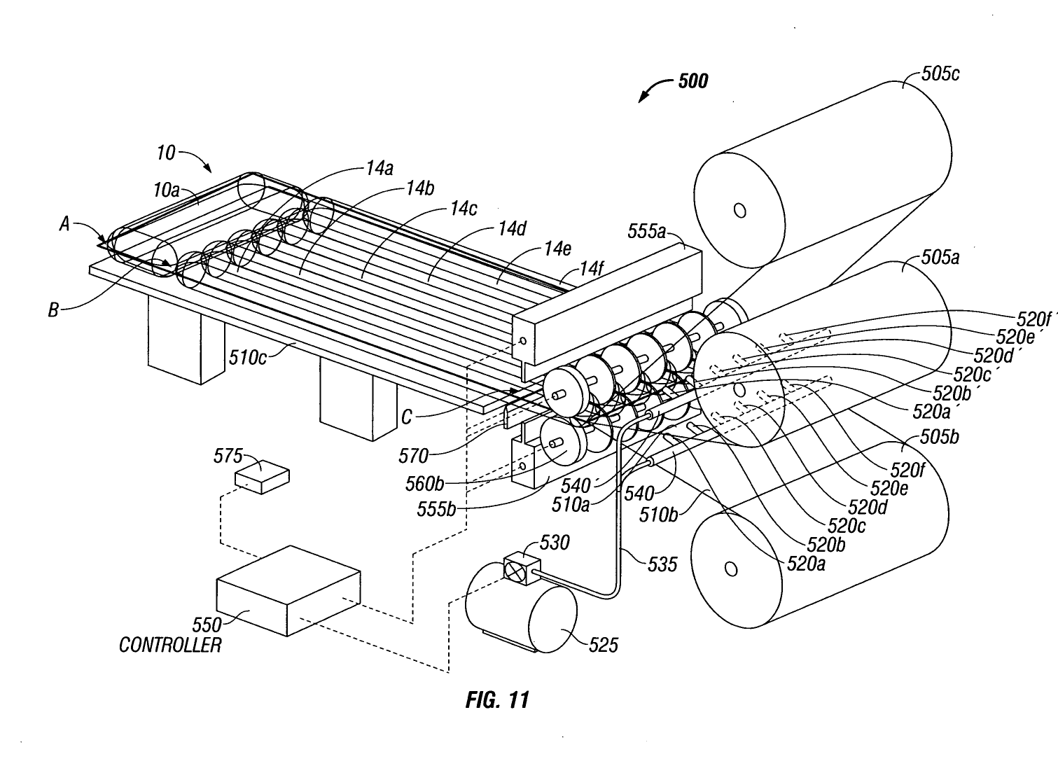

In the embodiment of FIG. 11, a mattress 10 with multilayered, or multiple layered configuration may be made for comfort, or alternatively, for manufacturing several discrete mattresses 10 at substantially the same time. In this embodiment, the machine 500 includes three rolls 505a, 505b, and 505c of thermoplastic sheets, and also includes nozzle sets 520a through 520f, and 520a′ through 520f′ for inflating the multiple layers. Preferably, heat sealers 555a, 555b are moveable as discussed above, and are configured to seal the multiple sheets forming the multiple layer air mattress 10 together, once inflated by nozzles 520a through 520f, and 520a′ through 520f′, and by source 525. It should be appreciated that more than three layers, such as, for example, four or five layers or more may be used to manufacture the multilayered mattress 10.

While this invention has been particularly shown and described with references to example embodiments thereof, it will be understood by those skilled in the art that various changes in form and details may be made therein without departing from the scope of the invention encompassed by the appended claims.

What is claimed is:

1. A method for selling an inflated bedding material to a consumer in an automated manner, the method comprising:
receiving payment from the consumer;
manufacturing an inflated bedding material; and
releasing the bedding material to the consumer.

2. The method of claim 1, further comprising manufacturing the inflated bedding material by:
sealing a first sheet and a second sheet together to form a pouch with a closed end and an open end;
venting a gas into the pouch through the open end to inflate the pouch; and
sealing the open end of the pouch to form the sealed inflated bedding material.

3. The method of claim 2, further comprising:
receiving a parameter of the inflated bedding material from the consumer, and
manufacturing the inflated bedding material in a manner complementary to the parameter.

4. The method of claim 1, further comprising:
recycling the manufactured bedding material.

5. The method of claim 4, further comprising recycling the manufactured bedding material by:
shredding the inflated bedding material; and
compacting the shredded bedding material for later retrieval.

6. The method of claim 3, further comprising receiving a length parameter of the inflated bedding material from the consumer, and manufacturing the inflated bedding material in a manner complementary to the length parameter.

7. The method of claim 3, further comprising receiving a width parameter of the inflated bedding material from the consumer, and manufacturing the inflated bedding material in a manner complementary to the width parameter.

8. The method of claim 3, further comprising receiving a thickness parameter of the inflated bedding material from the consumer, and manufacturing the inflated bedding material in a manner complementary to the thickness parameter.

9. The method of claim 3, further comprising receiving a pressure parameter of the inflated bedding material from the consumer, and manufacturing the inflated bedding material in a manner complementary to the pressure parameter.

10. The method of claim 1, further comprising receiving electronic funds, paper denominated funds, coin denominated funds, or any combination thereof as payment.

11. The method of claim 1, further comprising providing the inflated bedding material without payment.

12. The method of claim 3, further comprising:
receiving the parameter of the inflated bedding material from an input device located on or separate from a vending machine housing.

13. The method of claim 1, further comprising releasing the inflated bedding material to the consumer through a vending machine output.

14. The method of claim 13, further comprising releasing the inflated bedding material through the vending machine output on to a track extending adjacent to the vending machine output.

15. The method of claim 2, further comprising venting compressed air between the first sheet and the second sheet to form the pouch.

16. The method of claim 2, further comprising heat sealing the open end of the pouch to form the sealed inflated bedding material using a rotating heat sealing member.

17. The method of claim 2, further comprising heat sealing the open end of the pouch using a plurality of heat sealing members that move vertically relative to one another.

18. The method of claim 2, further comprising heat sealing the pouch using at least one heat sealing roller.

19. The method of claim 1, further comprising receiving payment before or after the inflated bedding material is released.

20. The method of claim 1, further comprising receiving a voucher from the consumer instead of payment.

21. The method of claim 1, further comprising manufacturing the inflated bedding material from a prefabricated material.

22. A vending machine configured to sell an inflated bedding material to a consumer in an automated manner, the vending machine comprising:
a device configured to receive funds;
a device configured to manufacture an inflated bedding material; and
a vending machine housing having an exit configured to release the manufactured inflated bedding material.

23. The vending machine of claim 22, further comprising an input device configured to receive an input parameter of an inflated bedding material from the consumer; and
a controller configured to control the device configured to manufacture the inflated bedding material to make the inflated bedding material in a manner complementary to the input parameter.

24. The vending machine of claim 22, wherein the device configured to manufacture the inflated bedding material comprises:
a first roller including a sheet of a first material;
a source of compressed air;
a heat sealer;
a controller; and
the sheet configured to extend from the roller and be sealed in a first location to form a pouch with an open end, and a closed end, the source of compressed air filling the pouch with air through the open end, and the inflated pouch sealed at the closed end by the heat sealer to form the sealed inflated bedding material.

25. The vending machine of claim 22, wherein the device configured to manufacture the inflated bedding material comprises:
a roller having a prefabricated bedding material; and
a source of compressed air.

26. The vending machine of claim 22, wherein the sheet is a malleable material.

27. The vending machine of claim 24, further comprising a second roller including a second sheet of a second material.

28. The vending machine of claim 27, wherein the first material and the second material are the same or different materials.

29. The vending machine of claim 28, wherein the first roller is spaced from the second roller, and the source of compressed air includes a nozzle positioned between the first roller and the second roller.

30. The vending machine of claim 24, wherein the heat sealer comprising a rotatable heat sealer.

31. The vending machine of claim 24, further comprising a first heat sealer, and a second heat sealer, the first heat sealer and the second heat sealer moving vertically relative to one another.

32. The vending machine of claim 24, wherein the heat sealer further comprises a plurality of heat sealer rollers.

33. The vending machine of claim 22, further comprising a track being located adjacent to the exit to receive the inflated bedding material.

34. The vending machine of claim 32, wherein the plurality of heat sealer rollers are configured to seal the pouch in a plurality of lengthwise segments.

35. The vending machine of claim 30, wherein the rotating heat sealer forms the inflatable bedding material with at least a first pouch, and a second pouch;
wherein the rotating heat sealer contacts the sheet of first material to form a first pouch with a first opened end, and a second closed end, and the source of compressed air fills the first pouch with compressed air through the first opened end;
wherein the rotating heat sealer rotates in a first rotational direction to contact the first inflated pouch to seal the first inflated pouch at the first opened end;
wherein the rotating heat sealer rotates in an opposite rotational direction to form the second pouch with a second opened end, and a second closed end, the source of compressed air filling the second pouch by introducing the compressed air through the second opened end; and
wherein the rotating heat sealer rotates in the first rotational direction to seal the second inflated pouch at the second opened end.

36. The vending machine of claim 24, wherein the heat sealer cuts the inflated bedding material from the sheet to release the inflated bedding material.

37. The vending machine of claim 24, further comprising a blade configured to cut the inflated bedding material from the sheet to release the inflated bedding material.

38. The vending machine of claim 28, wherein at least one of the first material and the second material is a thermoplastic.

39. The vending machine of claim 22, further comprising an inlet on the vending machine housing being configured to receive the bedding material for recycling.

40. The vending machine of claim 39, further comprising a shredding device being disposed adjacent the inlet, and configured to shred the bedding material for storage in or out of the vending machine.

41. A vending machine configured to sell a disposable bedding material to a consumer in an automated manner comprising:
means for receiving payment from the consumer;
means for manufacturing the bedding material; and
means for releasing the bedding material to the consumer.

42. A method for selling an inflated bedding material to a consumer in an automated manner comprising:
receiving payment from the consumer;
inflating a prefabricated bedding material; and
releasing the inflated bedding material to the consumer.

43. A machine configured to manufacture a mattress in an automated manner, the machine comprising:
means for manufacturing the mattress; and
a housing having an exit configured to release the manufactured mattress.

44. The machine of claim 43, further comprising an input device configured to receive an input parameter of the mattress; and
a controller configured to control the means for manufacturing the mattress to manufacture the mattress in a manner complementary to the input parameter.

45. The machine of claim 43, wherein the means for manufacturing the mattress comprises:
a first roller including a sheet of a first material;
a source of compressed air;
a heat sealer;
a controller; and
the sheet configured to extend from the roller and be sealed in a first location to form a pouch with an open end, and a closed end, the source of compressed air filling the pouch with air through the open end, and the inflated pouch sealed at the closed end by the heat sealer to form the sealed mattress.

46. The machine of claim 43, wherein the means for manufacturing the mattress is configured to manufacture a plurality of mattresses.

47. The machine of claim 46, wherein the means for manufacturing the mattress is configured to manufacture the plurality of mattresses for use in a location selected by the group consisting of:
a hospital, a daycare center, a camp, an airport, an emergency center, a nursing home, and a location associated with care, an emergency, or a humanitarian operation.

48. The machine of claim 43, wherein the machine is mobile.

49. The machine of claim 48, further comprising a mobile power supply, and wherein the means for manufacturing the mattress is configured to manufacture the plurality of mattresses using at least more than two rolls of material.

50. The machine of claim 43, wherein the machine manufactures the mattress in response to a humanitarian need or an emergency situation without receiving funds.
